(19) United States
(12) Patent Application Publication
(10) Pub. No.: US 2021/0266655 A1
(43) Pub. Date: Aug. 26, 2021

(54) HEADSET CONFIGURATION MANAGEMENT

(71) Applicant: QUALCOMM Incorporated, San Diego, CA (US)

(72) Inventors: Brijesh Nareshkumar PATEL, Hyderabad (IN); Indranil CHAKRABORTY, Hyderabad (IN); Venkata Mahesh LANKA, Visakhapatnam (IN); Sreekanth AILA, Hyderabad (IN)

(21) Appl. No.: 16/802,255

(22) Filed: Feb. 26, 2020

(51) Int. Cl. H04R 1/10; G10L 25/51; G06F 3/16; G10L 25/84; G10L 15/22; G10L 15/08

(52) U.S. Cl. CPC H04R 1/1041; G10L 25/51; G06F 3/165; G10L 25/84; G10L 2015/223; G10L 15/08; H04R 2420/07; G10L 2015/088; G10L 15/22

(57) ABSTRACT

A device for headphone audio management includes a processor that is configured to receive an audio signal corresponding to audio received by one or more microphones. The processor is also configured to process the audio signal using an audio classifier to generate a classification result for a first portion of the audio signal. The processor is further configured to, based on determining that the classification result indicates that the first portion of the audio signal corresponds to relevant audio, update a headset configuration of a headset to enable a second portion of the audio signal to be output by the headset.

### I. FIELD

The present disclosure is generally related to headset configuration management.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Computing devices are often used to consume media content with a connected headset. The headset can include noise cancellation and other features to reduce external noise. A user wearing a headset can inadvertently miss relevant external audio information. For example, the user may not realize that another user is speaking to them until the other user physically taps them on the shoulder. As another example, the user could fail to hear an announcement or an alarm. Even in cases where the user realizes the presence of relevant external audio, the user can miss an initial portion of the external audio because of the delay between the realization and providing user input to the computing device to pause the media content being played back via the headset.

### III. SUMMARY

In a particular aspect, a device for headphone audio management includes a processor that is configured to receive an audio signal corresponding to audio received by one or more microphones. The processor is also configured to process the audio signal using an audio classifier to generate a classification result for a first portion of the audio signal. The processor is further configured to, based on determining that the classification result indicates that the first portion of the audio signal corresponds to relevant audio, update a headset configuration of a headset to enable a second portion of the audio signal to be output by the headset.

In another particular aspect, a method of headphone audio management includes receiving, at a device, an audio signal corresponding to audio received by one or more microphones. The method also includes processing, at the device, the audio signal using an audio classifier to generate a classification result for a first portion of the audio signal. The method further includes, based on determining that the classification result indicates that the first portion of the audio signal corresponds to relevant audio, updating a headset configuration of a headset to enable a second portion of the audio signal to be output by the headset.

In another particular aspect, a computer-readable storage device stores instructions that, when executed by a processor, cause the processor to receive an audio signal corresponding to audio received by one or more microphones. The instructions also cause the processor to process the audio signal using an audio classifier to generate a classification result for a first portion of the audio signal. The instructions further cause the processor to, based on determining that the classification result indicates that the first portion of the audio signal corresponds to relevant audio, update a headset configuration of a headset to enable a second portion of the audio signal to be output by the headset.

In another particular aspect, an apparatus for headphone audio management includes means for processing an audio signal corresponding to audio received by one or more microphones using an audio classifier to generate a classification result for a first portion of the audio signal. The apparatus also includes means for updating a headset configuration of a headset to enable a second portion of the audio signal to be output by the headset. The headset configuration is updated based on determining that the classification result indicates that the first portion of the audio signal corresponds to relevant audio.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform headset configuration management, in accordance with some examples of the present disclosure;

FIG. 2 is a diagram of an illustrative example of update criteria that may be used by a system operable to perform headset configuration management, in accordance with some examples of the present disclosure;

FIG. 3A is a diagram of an illustrative example of providing a negative feedback to train an audio classifier for headset configuration management, in accordance with some examples of the present disclosure;

FIG. 3B is a diagram of an illustrative example of providing a positive feedback to train an audio classifier for headset configuration management, in accordance with some examples of the present disclosure;

FIG. 4 is a diagram of an illustrative example of a system operable to train an audio classifier for headset configuration management, in accordance with some examples of the present disclosure;

FIG. 5 is a flow chart illustrating a method of headset configuration management, in accordance with some examples of the present disclosure;

FIG. 6A is a diagram of a virtual reality or augmented reality headset operable to perform headset configuration management, in accordance with some examples of the present disclosure;

FIG. 6B is a diagram of a wearable electronic device operable to perform headset configuration management, in accordance with some examples of the present disclosure; and

FIG. 7 is a block diagram of a particular illustrative example of a device that is operable to perform headset configuration management, in accordance with some examples of the present disclosure.

### V. DETAILED DESCRIPTION

Systems and methods of performing headset configuration management are disclosed. A headset includes one or more microphones to receive external sounds and one or more speakers to output an output audio signal. In some examples, the headset performs noise cancellation based on an audio signal corresponding to audio received by the microphones so that a user can hear a sound output of the speakers corresponding to media content with reduced (e.g., no) interference from external sounds. A computing device coupled to, or integrated into, the headset includes a signal processing unit that includes an audio classifier and a headset configuration manager. According to some aspects, the audio classifier classifies portions of the audio signal in real-time as the audio signal is received. For example, the audio classifier generates a classification result corresponding to a portion of the audio signal. The classification result indicates whether the portion of the audio signal corresponds to relevant audio, such as speech instead of noise.

The headset configuration manager, in response to determining that the classification result indicates relevant audio, updates a headset configuration of the headset to enable audio corresponding to the audio signal to be output by the headset. For example, the audio output by the headset corresponds to the audio received by the one or more microphones. In a particular example, the headset configuration manager also pauses playback of the output audio signal by the headset. The external sounds received by the microphones are thus passed through to a wearer of the headset while playback of the media content is paused. The headset configuration manager resets (e.g., restores) the headset configuration in response to receiving a user input, e.g., to resume playback of the output audio signal corresponding to the media content and to cancel the external sounds received by the microphones.

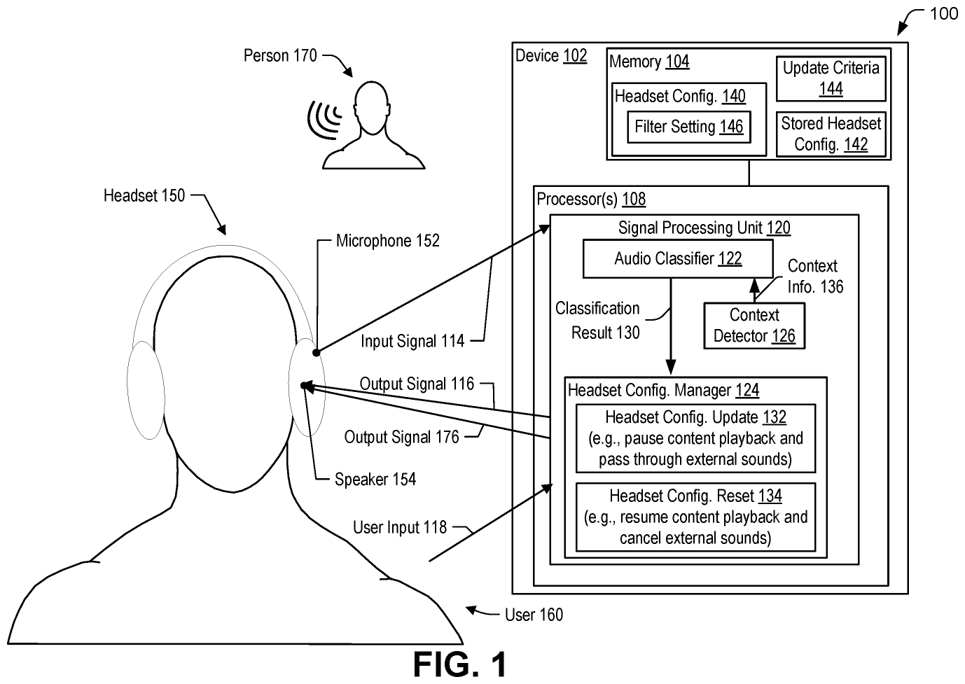

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 in FIG. 1), which indicates that in some implementations the device 102 includes a single processor 108 and in other implementations the device 102 includes multiple processors 108. For ease of reference herein, such features are generally introduced as “one or more” features, and are subsequently referred to in the singular unless aspects related to multiple of the features are being described.

It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system operable to perform headset configuration management is disclosed and generally designated 100. The system 100 includes a device 102 that is coupled to a headset 150. In a particular implementation, the device 102 is integrated into the headset 150. In an alternative implementation, the device 102 includes a portable device that is configured to wirelessly communicate with the headset 150. The headset 150 includes one or more microphones, such as a microphone 152, configured to capture sounds external to the headset 150 and to provide input signals corresponding to the captured sounds to the device 102. The headset 150 includes one or more speakers, such as a speaker 154, configured to output sound corresponding to output signals received from the device 102.

The device 102 includes one or more processors 108 coupled to a memory 104. The memory 104 is configured to store data used or generated by the device 102. For example, the memory 104 is configured to store a headset configuration 140 of the headset 150. In a particular example, the memory 104 is configured to store update criteria 144 that indicate whether relevant audio is detected and the headset configuration 140 is to be updated, as described herein. In a particular example, the memory 104 is configured to store a pre-update version of the headset configuration 140, such as a stored headset configuration 142, to enable restoration of the headset configuration 140, as described herein.

The processor 108 includes a signal processing unit 120. The signal processing unit 120 includes an audio classifier 122 and a headset configuration manager 124. The audio classifier 122 is configured to analyze portions of an input signal that corresponds to audio received by the one or more microphones to generate a classification result 130 indicating whether relevant audio is detected. The headset configuration manager 124 is configured to perform a headset configuration update 132 in response to receiving the classification result 130 indicating that relevant audio is detected. For example, performing the headset configuration update 132 includes updating a headset configuration 140 so that the external sounds captured by the microphone 152 are passed through to a wearer of the headset 150, such as by enabling sound corresponding to the input signals to be output by the speakers of the headset 150.

In some implementations, the signal processing unit 120 includes a context detector 126. The context detector 126 is configured to determine a context associated with the input signals and to generate context information 136 indicating the context. In a particular implementation, the audio classifier 122 generates the classification result 130 based at least in part on the context information 136. For example, in some implementations, the audio classifier 122 is configured to classify an input signal 114 (corresponding to audio received by the microphone 152) as including relevant audio in response to determining that the input signal 114 corresponds to sounds associated with emergency vehicles and the context information 136 indicates that the device 102 is proximate to a road.

During operation, in an illustrative example, a user 160 selects media content at the device 102 (e.g., music, video, an audiobook, or a combination thereof) for playback. The signal processing unit 120 generates an output signal 116 based at least in part on the media content. For example, the output signal 116 may be based on the media content, based on the input signal 114 corresponding to external sounds captured by the microphone 152, or both. To illustrate, in some implementations, the signal processing unit 120 generates the output signal 116 by applying noise cancellation techniques to reduce (e.g., cancel) the external sounds corresponding to the input signal 114. In a particular example, at least a portion of the output signal 116 can be independent of any media content. To illustrate, in an example in which the user 160 is an aircraft pilot, the user 160 wears the headset 150 for noise cancellation with intermittent communication from a control tower or other cockpit crew.

In a particular implementation, the input signal 114 is generated by the microphone 152. In an alternative implementation, the input signal 114 is based on an audio signal generated by the microphone 152. For example, the microphone 152 generates the audio signal, a CODEC generates the input signal 114 by encoding the audio signal, and the audio classifier 122 receives the input signal 114 from the CODEC (e.g., via a communication bus or wireless transmission, as illustrative examples).

The signal processing unit 120 provides (e.g., streams) the output signal 116 to the headset 150 for playback by the speaker 154, by one or more additional speakers, or a combination thereof, of the headset 150. The output signal 116 enables the user 160 to experience playback of the selected the media content with reduced interference (e.g., no interference) from external sounds. In a particular example, the output signal 116 enables the user 160 to experience reduced external noise independently of playback of any media content.

During streaming of the output signal 116 to the headset 150, the audio classifier 122 analyzes the context information 136, the input signal 114 corresponding to audio received by the microphone 152, or both, to determine whether relevant audio is detected. For example, in some implementations, the input signal 114 is streamed to the device 102 while the steaming of the output signal 116 is ongoing. The audio classifier 122 analyzes sequentially received portions (e.g., frames or groups of frames that are overlapping or non-overlapping) of the input signal 114 to determine whether relevant audio is detected. In addition, the context detector 126 updates the context information 136, e.g., based on sensor data, so that the audio classifier 122 operates on real-time environmental sound and other contextual information. In a particular implementation, the audio classifier 122 includes an artificial neural network. In this implementation, the audio classifier 122 extracts one or more features from an audio portion of the input signal 114, the context information 136, or a combination thereof, and generates the classification result 130 by using the artificial neural network to process the extracted features.

In an implementation where the classification result 130 is based at least in part on the context information 136, the context detector 126 generates the context information 136 indicating a context associated with a first audio portion of the input signal 114. For example, the context detector 126 updates the context information 136 based on sensor data, user data, or a combination thereof. In a particular implementation, the context detector 126 updates the context information 136 in response to detecting a context update condition, such as expiration of a timer, an update in sensor data, an update in user data, or a combination thereof. In a particular implementation, the audio classifier 122 considers the most recent version of the context information 136 as associated with a portion of the input signal 114 (e.g., the first audio portion) being analyzed.

In a particular aspect, the context information 136 is based on sensor data received from one or more sensors of the device 102, the headset 150, or both, user data associated with the user 160, or a combination thereof. In a particular aspect, the one or more sensors include a location sensor. For example, the context information 136 indicates a geographical location of the device 102 most recently detected by a global positioning system (GPS) receiver of the device 102 prior to or approximately at the same time as receiving the first audio portion. In a particular aspect, the one or more sensors include an image sensor of the headset 150, an image sensor the device 102, or both. In an example, the context information 136 indicates that a person 170 (e.g., a flight attendant) is looking in the direction of the user 160 and appears to be speaking, gesturing, or both, towards the user 160. In a particular aspect, the context detector 126 operates on user data that includes calendar data. For example, the context information 136 indicates an activity associated with the user 160 that is scheduled for approximately the same time as the time of receipt of the first audio portion. To illustrate, the context information 136 indicates that the user 160 is at work.

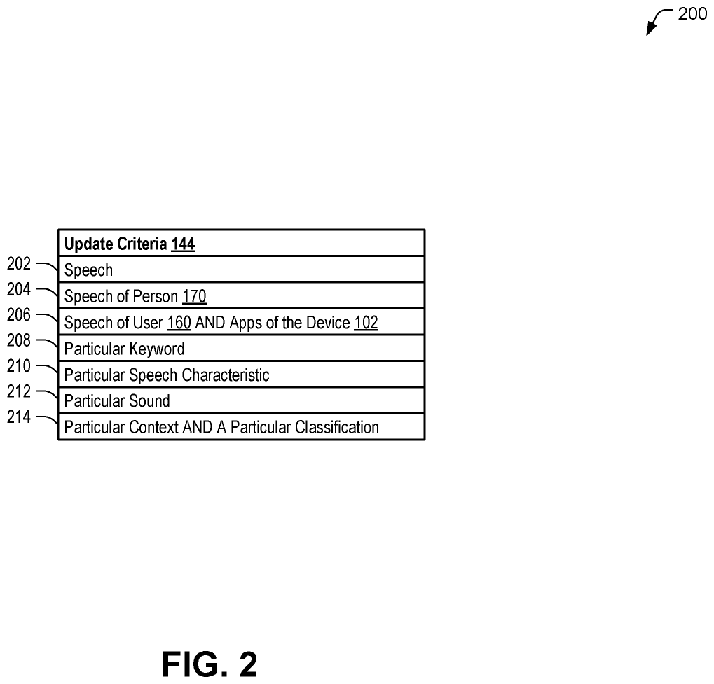

The audio classifier 122 determines whether the first audio portion satisfies the update criteria 144, as further described with reference to FIG. 2. In a particular implementation, the update criteria 144 are based at least in part on a context of the first audio portion, as further described with reference to FIG. 2. For example, the audio classifier 122 may be configured to determine that at least one of the update criteria 144 are satisfied in response to determining that the context information 136 indicates that the user 160 is at work and that the first audio portion is classified as speech of a person 170 that is identified as a source of relevant audio (e.g., a particular co-worker). As another example, the audio classifier 122 may be configured to determine that at least one of the update criteria 144 is not satisfied in response to determining that the context information 136 indicates that the user 160 is at work and that the first audio portion is classified as speech of another user that is not identified as a source of relevant audio (e.g., another co-worker who frequently speaks to other people).

The audio classifier 122, in response to determining that the first audio portion satisfies at least one of the update criteria 144, generates a classification result 130 having a first value (e.g., 1) indicating that relevant audio is detected in the first audio portion. Alternatively, the audio classifier 122, in response to determining that the first audio portion satisfies none of the update criteria 144, generates the classification result 130 having a second value (e.g., 0) indicating that the first audio portion corresponds to non-relevant audio. In a particular implementation, the update criteria 144 include one or more logical tests and the audio classifier 122 determines whether any of the logical tests are satisfied. In a particular aspect, the update criteria 144 are based on user input, default data, configuration data, or a combination thereof.

The audio classifier 122 provides the classification result 130 to the headset configuration manager 124. The headset configuration manager 124, in response to determining that the classification result 130 has the second value (e.g., 0) indicating that the first audio portion does not correspond to relevant audio, refrains from updating the headset configuration 140 responsive to receiving the first audio portion. Alternatively, the headset configuration manager 124, in response to determining that the classification result 130 has the first value (e.g., 1) indicating that the first audio portion corresponds to relevant audio, performs a headset configuration update 132 to enable a second audio portion (e.g., subsequent to the first audio portion) of the input signal 114 to be played out to the user 160 via the speaker 154 so that the user 160 can hear the relevant audio.

In a particular implementation, performing the headset configuration update 132 includes copying a current version of the headset configuration 140 of the headset 150, at a first time, and storing the copy in the memory 104 as a stored headset configuration 142. For example, the stored headset configuration 142 corresponds to a user-selected media content playback operation that includes providing the output signal 116 for playback at the speaker 154. Performing the headset configuration update 132 includes updating the headset configuration 140 of the headset 150. For example, the updated version of the headset configuration 140 corresponds to providing an output signal 176 for playback at the speaker 154. The output signal 176 is based on the input signal 114, such as to enable playback of the relevant sound to the user 160. In a particular aspect, the output signal 176 is also based in part on the media content. For example, in some implementations, the output signal 176 includes the media content at a reduced volume as compared to the output signal 116. To illustrate, updating the headset configuration 140 includes reducing an output volume of an audio signal corresponding to the media content that is output by the speaker 154. In an alternative aspect, the output signal 176 is independent of the media content (e.g., media content playback is interrupted). For example, updating the headset configuration 140 includes automatically pausing output of the media content (e.g., the output signal 116) by the speaker 154 to enable the user 160 to hear external sounds, such as speech of the person 170. In a particular aspect, updating the headset configuration 140 includes deactivating a filter setting 146 that provides noise cancellation.

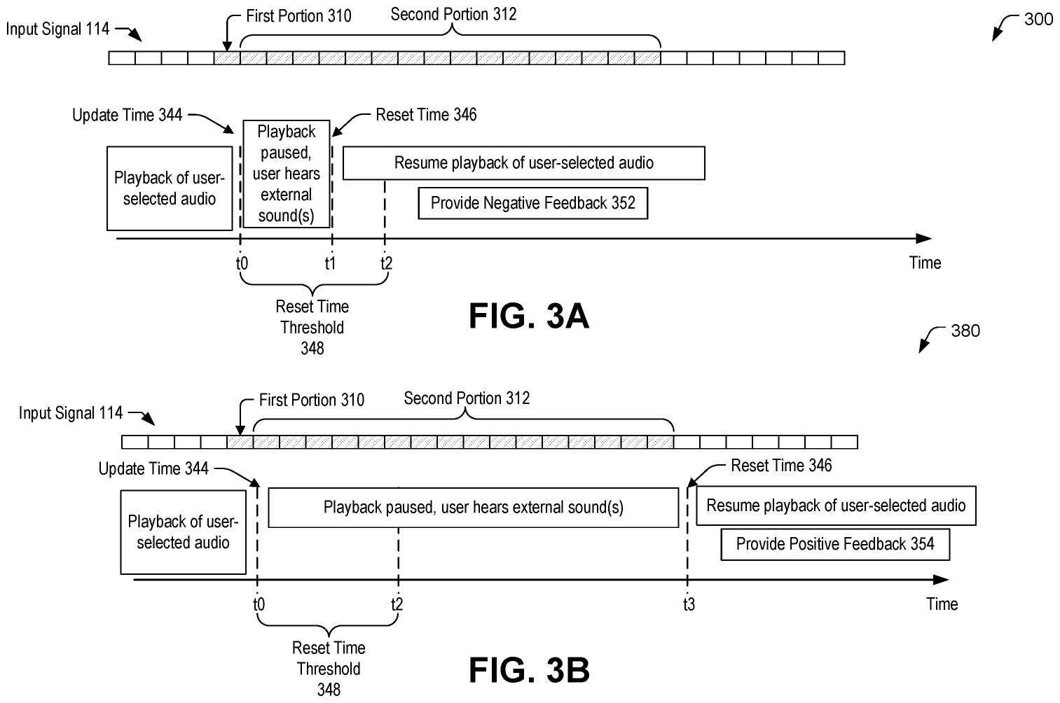

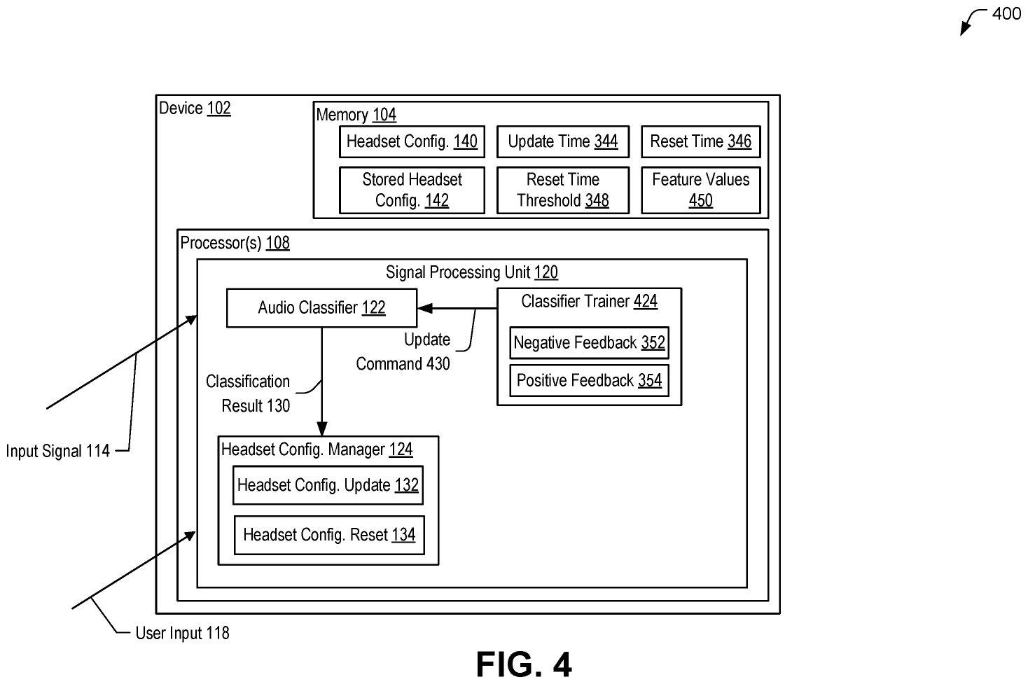

In a particular aspect, the headset configuration manager 124, subsequent to performing the headset configuration update 132, receives a user input 118 from the user 160 indicating that the headset configuration 140 is to be reset. In some examples, the user input 118 includes an audio command, a gesture, a touchscreen input, a hardware button activation, or a combination thereof. The headset configuration manager 124 is configured to reset the headset configuration 140. For example, the headset configuration manager 124, in response to receiving the user input 118, performs a headset configuration reset 134 to restore the headset configuration 140, such as by copying the stored headset configuration 142 to the headset configuration 140. Restoring the headset configuration 140 enables playback of the user-selected media content to resume, noise-cancellation to be enabled, or both. In a particular aspect, the device 102 includes a classifier trainer configured to update (e.g., train) the audio classifier 122 based on the user input 118, as further described with reference to FIGS. 3-4.

The system 100 thus enables automatically updating the headset configuration 140 to enable external sounds to pass through to a wearer (e.g., the user 160) of the headset 150 when relevant audio is detected. The automatic update of the headset configuration 140 reduces a delay (as compared to a user-initiated update) between the microphone 152 receiving the relevant audio and the headset 150 being reconfigured to enable external audio to pass through to the user 160. As a result, more (e.g., all) of the relevant audio is passed through to the user 160 as compared to conventional systems.

Referring to FIG. 2, an example of the update criteria 144 is shown and generally designated 200. In a particular example, the update criteria 144 include an update criterion 202 that indicates speech. To illustrate, the audio classifier 122 includes a speech-noise classifier that classifies portions of the input signal 114 of FIG. 1 into speech or noise. In this example, the audio classifier 122, in response to determining that a first audio portion of the input signal 114 corresponds to speech, determines that the update criterion 202 is satisfied by the first audio portion.

In a particular example, the update criteria 144 include an update criterion 204 that indicates speech of a particular person (e.g., the person 170). To illustrate, the audio classifier 122 includes a speaker recognizer that classifies portions of the input signal 114 as corresponding to various users or as corresponding to an unknown user. In this example, the audio classifier 122, in response to determining that the first audio portion corresponds to speech of a particular user (e.g., the person 170), determines that the update criterion 204 is satisfied. In a particular aspect, the update criteria 144 include either the update criterion 202 or the update criterion 204, but not both.

In a particular example, the update criteria 144 include an update criterion 206 that indicates speech of the user 160 (e.g., the wearer) of the headset 150 and one or more applications (apps) of the device 102. The apps include a voice communication application (e.g., an audio call application), an audio transcription application, a karaoke application, another speech-based application, or a combination thereof. In this example, the audio classifier 122, in response to determining that the first audio portion corresponds to speech of the wearer of the headset 150 (e.g., the user 160) and that none of the apps indicated by the update criterion 206 are active, determines that the update criterion 206 is satisfied. For example, the update criterion 206 is satisfied when the user 160 starts speaking to the person 170. In another example, the update criterion 206 is not satisfied when the user 160 is using the headset 150 and the device 102 to make an audio call. In a particular aspect, the update criteria 144 include either the update criterion 202 or the update criterion 206, but not both.

In a particular example, the update criteria 144 include an update criterion 208 that indicates a particular keyword (e.g., a spoken keyword). For example, the audio classifier 122 includes a speech recognizer that recognizes speech in portions of the input signal 114. In this example, the audio classifier 122, in response to determining that the first audio portion corresponds to the particular keyword indicated by the update criterion 208, determines that the update criterion 208 is satisfied. In an illustrative example, the particular keyword includes a name of the user 160, a name of another person, or another topic of interest to the user 160.

In a particular example, the update criteria 144 include an update criterion 210 that indicates a particular speech characteristic. For example, the audio classifier 122 identifies speech characteristics (e.g., singing, announcement, talking, loud, etc.) associated with portions of the input signal 114. In this example, the audio classifier 122, in response to determining that the first audio portion corresponds to the particular speech characteristic (e.g., talking) indicated by the update criterion 210, determines that the update criterion 210 is satisfied.

In a particular example, the update criteria 144 include an update criterion 212 that indicates a particular sound. For example, the audio classifier 122 identifies particular sounds (e.g., a fire truck, an ambulance, a police siren, another emergency vehicle, a car horn, a fire alarm, a security alarm, another alarm, etc.) associated with portions of the input signal 114. In this example, the audio classifier 122, in response to determining that the first audio portion corresponds to the particular sound (e.g., a fire alarm) indicated by the update criterion 212, determines that the update criterion 212 is satisfied.

In a particular example, the update criteria 144 include an update criterion 214 that indicates a particular context and a particular audio classification. For example, the particular audio classification can indicate speech, speech of a particular user (e.g., the person 170), speech of the wearer (e.g., the user 160) of the headset 150, a particular spoken keyword, a particular speech characteristic, a particular sound, or a combination thereof. The audio classifier 122 determines that the update criterion 214 is satisfied in response to determining that the context information 136 and the first audio portion match the particular context and the particular classification, respectively, indicated by the update criterion 214.

In a particular aspect, the update criteria 144 can include an update criterion that is a logical combination of one or more criterions. It should be understood that the update criterion 202-214 are provided as non-limiting illustrative examples. In other aspects, the update criteria 144 can include fewer, more, or different update criteria than described with reference to FIG. 2.

Referring to FIG. 3A, an example of providing a negative feedback to train the audio classifier 122 is shown and generally designated 300. A simplified version of the input signal 114 is illustrated as a time-series of sequentially received portions (e.g., frames) with shaded portions that are classified by the device 102 as speech and unshaded portions that are classified by the device 102 as noise. The input signal 114 transitions from noise to speech at a first portion 310 and continues as speech to the end of a second portion 312, after which the input signal 114 returns to a noise signal. In a particular aspect, the device 102, prior to a time t0, provides the output signal 116 of FIG. 1 corresponding to user-selected audio for playback to the speaker 154. Upon detecting that the first portion 310 is classified as including speech content, the headset configuration manager 124 performs the headset configuration update 132 at an update time 344 (e.g., the time t0), as described with reference to FIG. 1. For example, performing the headset configuration update 132 includes pausing playback of the user-selected audio and enabling external sounds to pass through to the user 160. The headset configuration manager 124, in response to receiving the user input 118, performs the headset configuration update 132 at a reset time 346 (e.g., a time t1), as described with reference to FIG. 1. For example, performing the headset configuration update 132 includes resuming playback of the user-selected audio.

In FIG. 3A, a difference between the reset time 346 and the update time 344 is less than a reset time threshold 348. Resetting of the headset configuration 140 within the reset time threshold 348 of the update time 344 indicates that the headset configuration update 132 performed at the update time 344 is likely triggered by a false classification of a first audio portion of the input signal 114 as relevant audio. For example, if the user 160 resets the headset configuration 140 within the reset time threshold 348 then the headset configuration 140 should not have been updated at the update time 344. A classifier trainer, in response to determining that a difference between the reset time 346 and the update time 344 is less than the reset time threshold 348, provides a negative feedback 352 to the audio classifier 122, as further described with reference to FIG. 4.

Referring to FIG. 3B, an example of providing a positive feedback to train the audio classifier 122 is shown and generally designated 380. FIG. 3B differs from FIG. 3A in that a difference between the reset time 346 (e.g., a time t3) and the update time 344 (e.g., the time t0) is greater than or equal to the reset time threshold 348. Resetting of the headset configuration 140 at or after the reset time threshold 348 of the update time 344 indicates that the headset configuration update 132 performed at the update time 344 is likely triggered by a true classification of a first audio portion of the input signal 114 as relevant audio. For example, if the user 160 resets the headset configuration 140 at or after the reset time threshold 348 then the user 160 was probably listening to the external sounds passed through to the user 160 (e.g., the user 160 listened to the end of the second portion 312 of the input signal 114 before resetting the headset) and the headset configuration 140 was correctly updated at the update time 344 based on correctly detecting relevant audio in the first portion 310. A classifier trainer, in response to determining that a difference between the reset time 346 and the update time 344 is greater than or equal to the reset time threshold 348, provides a positive feedback 354 to the audio classifier 122, as further described with reference to FIG. 4.

The audio classifier 122 can thus be personalized to the preferences of the user 160. For example, the negative feedback 352 and the positive feedback 354 can be used to train the audio classifier 122 to detect audio that is relevant to the user 160.

Referring to FIG. 4, a particular implementation of a system operable to train the audio classifier 122 is shown and generally designated 400. For example, the signal processing unit 120 includes a classifier trainer 424 that is configured to train the audio classifier 122.

During operation, the audio classifier 122 generates one or more feature values 450 corresponding to a first audio portion of the input signal 114 (e.g., the first portion 310 of FIG. 3). For example, the feature values 450 are based on the first audio portion, the context information 136, or both. The audio classifier 122 generates the classification result 130, as described with reference to FIG. 1, based on the feature values 450. For example, the audio classifier 122 generates the classification result 130 by using an artificial neural network to process the feature values 450. The headset configuration manager 124 performs the headset configuration update 132 at an update time 344, as described with reference to FIGS. 1 and 3A. The headset configuration manager 124 stores the feature values 450 and a timestamp indicating the update time 344 in the memory 104.

The headset configuration manager 124 performs the headset configuration reset 134 at the reset time 346, as described with reference to FIGS. 1 and 3A. The classifier trainer 424, based on the update time 344, the reset time 346, and the reset time threshold 348, generates a feedback (e.g., a negative feedback 352 or a positive feedback 354), as described with reference to FIGS. 3A and 3B, associated with the feature values 450. The classifier trainer 424 uses neural network training techniques to generate an update command 430 based on the feedback (e.g., the negative feedback 352 or the positive feedback 354) and the feature values 450. The classifier trainer 424 sends an update command 430 to the audio classifier 122 (e.g., the artificial neural network). For example, the update command 430 updates one or more weights, one or more biases, or a combination thereof, of the audio classifier 122. The updated version of the audio classifier 122 generates a classification result 130 associated with a subsequent portion of the input signal 114.

The system 400 enables the audio classifier 122 to be personalized to the preferences of the user 160. For example, the negative feedback 352 and the positive feedback 354 can be used to train the audio classifier 122 to detect audio that is relevant to the user 160.

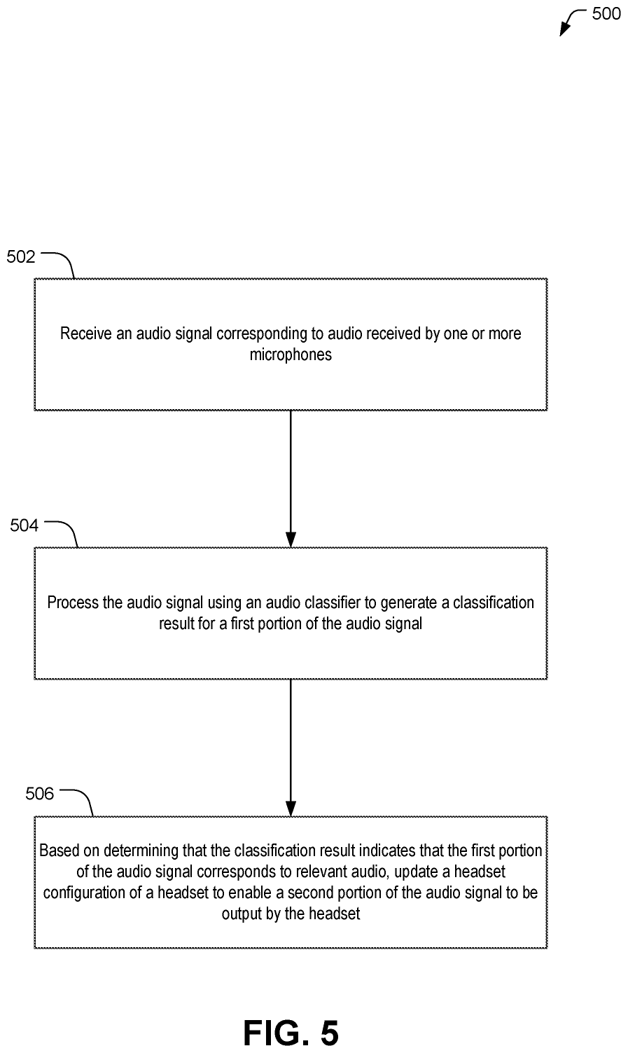

In FIG. 5, an example of a method of headset configuration management is shown and generally designated 500. In a particular aspect, one or more operations of the method 500 are performed by the audio classifier 122, the headset configuration manager 124, the context detector 126, the signal processing unit 120, the processor 108, the device 102, the headset 150, the system 100 of FIG. 1, the classifier trainer 424, the system 400 of FIG. 4, or a combination thereof.

The method 500 includes receiving an audio signal corresponding to audio received by one or more microphones, at 502. For example, the signal processing unit 120 of FIG. 1 receives the input signal 114 corresponding to audio received by the microphone 152, as described with reference to FIG. 1.

The method 500 also includes processing the audio signal using an audio classifier to generate a classification result for a first portion of the audio signal, at 504. For example, the audio classifier 122 of FIG. 1 processes the input signal 114 to generate the classification result 130 for a first audio portion of the input signal 114, as described with reference to FIG. 1.

The method 500 further includes, based on determining that the classification result indicates that the first portion of the audio signal corresponds to relevant audio, updating a headset configuration of a headset to enable a second portion of the audio signal to be output by the headset, at 506. For example, the headset configuration manager 124 of FIG. 1, based on determining that the classification result 130 indicates that the first audio portion corresponds to relevant audio, performs the headset configuration update 132 to update the headset configuration 140 of the headset 150 to enable a second audio portion of the input signal 114 to be output by the headset 150, as described with reference to FIG. 1.

In a particular aspect, the method 500 includes resetting the headset configuration in response to receiving a user input indicating that the headset configuration is to be reset. For example, the headset configuration manager 124 of FIG. 1 performs the headset configuration reset 134 to reset the headset configuration 140 in response to receiving the user input 118 indicating that the headset configuration 140 is to be reset, as described with reference to FIG. 1.

In a particular aspect, the method 500 also includes updating the audio classifier based on a comparison of a first time of the update to the headset configuration and a second time of receipt of the user input. For example, the classifier trainer 424 of FIG. 4 updates the audio classifier 122 based on a comparison of the update time 344 and the reset time 346, as described with reference to FIG. 1.

In a particular aspect, the method 500 includes updating the audio classifier by providing positive feedback associated with the classification result to the audio classifier in response to determining that a difference between the first time and the second time is greater than or equal to a threshold duration. For example, the classifier trainer 424 of FIG. 4 updates the audio classifier 122 by providing the positive feedback 354 associated with the classification result 130 to the audio classifier 122 in response to determining that a difference between the update time 344 and the reset time 346 is greater than or equal to the reset time threshold 348, as described with reference to FIGS. 3B and 4.

In a particular aspect, the method 500 includes updating the audio classifier by providing negative feedback associated with the classification result to the audio classifier in response to determining that a difference between the first time and the second time is less than a threshold duration. For example, the classifier trainer 424 of FIG. 4 updates the audio classifier 122 by providing the negative feedback 352 associated with the classification result 130 to the audio classifier 122 in response to determining that a difference between the update time 344 and the reset time 346 is less than the reset time threshold 348, as described with reference to FIGS. 3A and 4.

The method 500 thus enables automatically updating the headset configuration 140 to enable external sounds to pass through to a wearer (e.g., the user 160) of the headset 150 when relevant audio is detected. The automatic update of the headset configuration 140 reduces a delay (as compared to a user-initiated update) between the microphone 152 receiving the relevant audio and the headset 150 being reconfigured to enable the external audio to pass through to the user 160. As a result, more (e.g., all) of the relevant audio is passed through to the user 160 as compared to conventional systems. The method 500 can also enable the audio classifier 122 to be trained to detect audio that is relevant to the user 160 based on the user input 118.

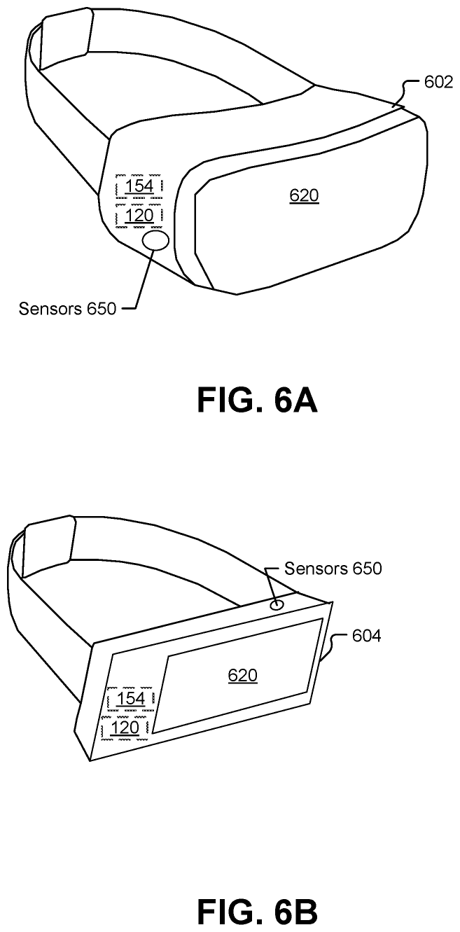

FIG. 6A depicts an example of the signal processing unit 120 integrated into a headset 602, such as a virtual reality, augmented reality, or mixed reality headset. A visual interface device, such as a display 620 is positioned in front of the user's eyes to enable display of augmented reality or virtual reality images or scenes to the user while the headset 602 is worn. In a particular example, the display 620 is configured to display information indicating that relevant audio has been detected and an option to provide the user input 118 of FIG. 1 to reset the headset configuration 140. Sensors 650 can include one or more microphones, cameras, or other sensors, and can include the microphone 152 of FIG. 1. The headset 602 includes one or more speakers, such as the speaker 154. Although illustrated in a single location, in other implementations one or more of the sensors 650 can be positioned at other locations of the headset 602, such as an array of one or more microphones and one or more cameras distributed around the headset 602 to detect multi-modal inputs.

FIG. 6B depicts an example of the signal processing unit 120 integrated into a wearable electronic device 604, illustrated as a “smart watch,” that includes the display 620, the sensors 650, and the speaker 154. The sensors 650 enable detection, for example, of relevant external audio based on modalities such as video, speech, and gesture.

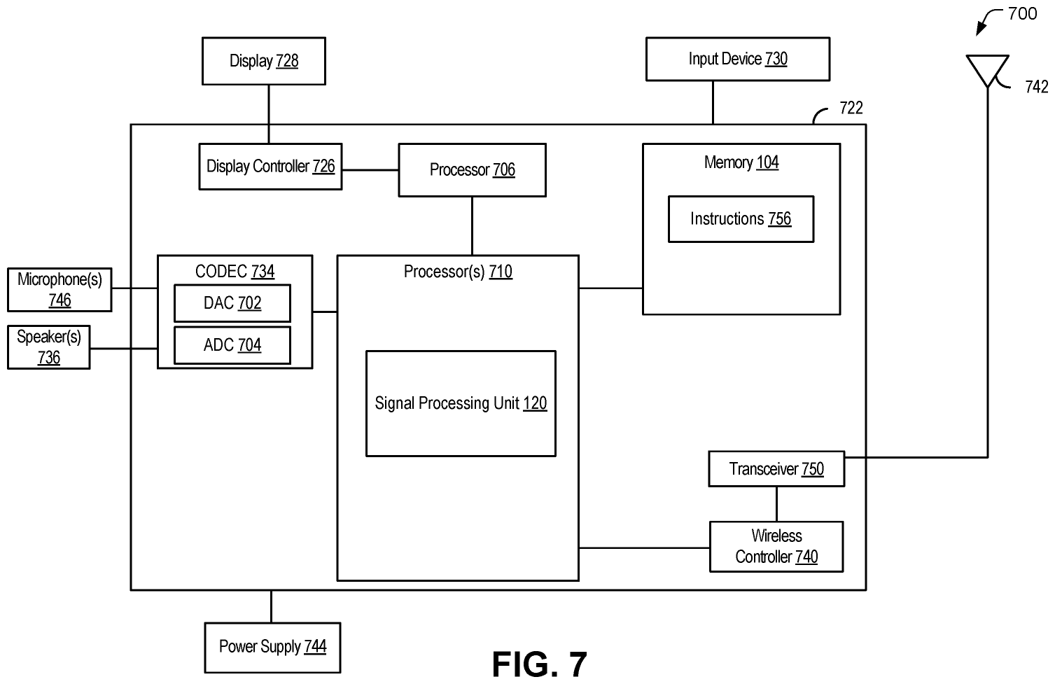

Referring to FIG. 7, a block diagram of a particular illustrative implementation of a device is depicted and generally designated 700. In various implementations, the device 700 may have more or fewer components than illustrated in FIG. 7. In an illustrative implementation, the device 700 may correspond to the device 102 of FIG. 1. In an illustrative implementation, the device 700 may perform one or more operations described with reference to FIGS. 1-6B.

In a particular implementation, the device 700 includes a processor 706 (e.g., a central processing unit (CPU)). The device 700 may include one or more additional processors 710 (e.g., one or more DSPs). The processor 710 may include the signal processing unit 120. In a particular aspect, the processor 108 of FIG. 1 corresponds to the processor 706, the processor 710, or a combination thereof.

The device 700 may include a memory 104 and a CODEC 734. The memory 104 may include instructions 756 that are executable by the one or more additional processors 710 (or the processor 706) to implement one or more operations described with reference to FIGS. 1-6B. In an example, the memory 104 includes a computer-readable storage device that stores the instructions 756. The instructions 756, when executed by one or more processors (e.g., the processor 108, the processor 706, or the processor 710, as illustrative examples), cause the one or more processors to receive an audio signal corresponding to audio received by one or more microphones. The instructions 756 also cause the one or more processors to process the audio signal using an audio classifier to generate a classification result for a first portion of the audio signal. The instructions 756 further cause the one or more processors to, based on determining that the classification result indicates that the first portion of the audio signal corresponds to relevant audio, update a headset configuration of a headset to enable a second portion of the audio signal to be output by the headset.

The device 700 may include a wireless controller 740 coupled, via a transceiver 750, to an antenna 742. The device 700 may include a display 728 coupled to a display controller 726. One or more speakers 736 and one or more microphones 746 may be coupled to the CODEC 734. In a particular aspect, the microphone 746 includes the microphone 152 of FIG. 1. In a particular aspect, the speaker 736 includes the speaker 154 of FIG. 1. The CODEC 734 may include a digital-to-analog converter (DAC) 702 and an analog-to-digital converter (ADC) 704. In a particular implementation, the CODEC 734 may receive analog signals from the microphone 746, convert the analog signals to digital signals using the analog-to-digital converter 704, and provide the digital signals to the processor 710. The processor 710 (e.g., a speech and music codec) may process the digital signals, and the digital signals may further be processed by the signal processing unit 120. In a particular implementation, the processor 710 (e.g., the speech and music codec) may provide digital signals to the CODEC 734. The CODEC 734 may convert the digital signals to analog signals using the digital-to-analog converter 702 and may provide the analog signals to the speakers 736. The device 700 may include an input device 730. In a particular aspect, the input device 730 includes an image sensor.

In a particular implementation, the device 700 may be included in a system-in-package or system-on-chip device 722. In a particular implementation, the memory 104, the processor 706, the processor 710, the display controller 726, the CODEC 734, and the wireless controller 740 are included in a system-in-package or system-on-chip device 722. In a particular implementation, the input device 730 and a power supply 744 are coupled to the system-in-package or system-on-chip device 722. Moreover, in a particular implementation, as illustrated in FIG. 7, the display 728, the input device 730, the speaker 736, the microphone 746, the antenna 742, and the power supply 744 are external to the system-in-package or system-on-chip device 722. In a particular implementation, each of the display 728, the input device 730, the speaker 736, the microphone 746, the antenna 742, and the power supply 744 may be coupled to a component of the system-in-package or system-on-chip device 722, such as an interface or a controller.

The device 700 may include a portable electronic device, a headset, a car, a vehicle, a computing device, a communication device, an internet-of-things (IoT) device, a virtual reality (VR) device, a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a mobile device, a mobile phone, or any combination thereof. In a particular aspect, the processor 706, the processor 710, or a combination thereof, are included in an integrated circuit.

In conjunction with the described implementations, an apparatus includes means for processing an audio signal corresponding to audio received by one or more microphones using an audio classifier to generate a classification result for a first portion of the audio signal. For example, the means for processing may include the processor 108, the audio classifier 122, the context detector 126, the signal processing unit 120, the device 102, the system 100 of FIG. 1, the system 400 of FIG. 4, the processor 706, the processor 710, one or more other circuits or components configured to process an audio signal corresponding to audio received by one or more microphones using an audio classifier, or any combination thereof.

The apparatus also includes means for updating a headset configuration of a headset to enable a second portion of the audio signal to be output by the headset. For example, the means for updating may include the processor 108, the headset configuration manager 124, the signal processing unit 120, the device 102, the system 100 of FIG. 1, the system 400 of FIG. 4, the processor 706, the processor 710, one or more other circuits or components configured to update a headset configuration of a headset to enable a second portion of an audio signal to be output by the headset, or any combination thereof. The headset configuration is updated based on determining that the classification result indicates that the first portion of the audio signal corresponds to relevant audio.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A device for headphone audio management, the device comprising:
a processor configured to:
receive an audio signal corresponding to audio received by one or more microphones;
process the audio signal using an audio classifier, wherein the audio classifier comprises a neural network, to generate a classification result for a first portion of the audio signal; and
based on determining that the classification result indicates that the first portion of the audio signal corresponds to relevant audio, update a headset configuration of a headset to enable a second portion of the audio signal to be output by the headset.

2. The device of claim 1, wherein the processor is configured to provide an output audio signal to the headset for playback, wherein the output audio signal includes user-selected media content and cancels external sounds, and wherein, upon updating the headset configuration, playback of the output audio signal is automatically paused to enable a wearer of the headset to hear the external sounds.

3. The device of claim 1, wherein the processor is integrated into the headset.

4. The device of claim 1, wherein the processor integrated into a portable device that is configured to wirelessly communicate with the headset.

5. (canceled)

6. The device of claim 1, wherein the audio classifier is configured to classify the first portion of the audio signal as relevant audio based on determining that the first portion of the audio signal corresponds to speech.

7. The device of claim 1, wherein the audio classifier is configured to classify the first portion of the audio signal as non-relevant audio based on determining that the first portion of the audio signal corresponds to noise.

8. The device of claim 1, wherein the audio classifier is configured to classify the first portion of the audio signal as relevant audio based on determining that the first portion of the audio signal corresponds to a particular keyword.

9. The device of claim 8, wherein the particular keyword includes a name of a user associated with the headset.

10. The device of claim 1, wherein the audio classifier is configured to classify the first portion of the audio signal as relevant audio based on determining that the first portion of the audio signal corresponds to an alarm.

11. The device of claim 1, wherein the audio classifier is configured to classify the first portion of the audio signal as relevant audio based on determining that the first portion of the audio signal corresponds to speech of a particular person.

12. The device of claim 1, wherein the audio classifier is configured to classify the first portion of the audio signal based at least in part on context information.

13. The device of claim 12, wherein the audio classifier is configured to, in response to determining that the context information indicates that the headset is detected proximate to a road, classify the first portion of the audio signal as relevant audio based on determining that the first portion of the audio signal corresponds to sounds associated with emergency vehicles.

14. The device of claim 1, wherein the processor is configured to reset the headset configuration in response to receiving a user input indicating that the headset configuration is to be reset.

15. The device of claim 14, wherein the user input includes an audio command, a gesture, a touchscreen input, a hardware button activation, or a combination thereof.

16. The device of claim 14, wherein the processor is configured to update the audio classifier based on a comparison of a first time of the update to the headset configuration and a second time of receipt of the user input.

17. The device of claim 16, wherein the processor is configured to update the audio classifier by providing positive feedback associated with the classification result to the audio classifier in response to determining that a difference between the first time and the second time is greater than or equal to a threshold duration.

18. The device of claim 16, wherein the processor is configured to update the audio classifier by providing negative feedback associated with the classification result to the audio classifier in response to determining that a difference between the first time and the second time is less than a threshold duration.

19. The device of claim 1, wherein updating the headset configuration includes reducing an output volume of a second audio signal output by the headset.

20. The device of claim 1, wherein updating the headset configuration includes deactivating a filter setting of the headset.

21. A method of headphone audio management, the method comprising:
receiving, at a device, an audio signal corresponding to audio received by one or more microphones;
processing, at the device, the audio signal using an audio classifier, wherein the audio classifier comprises a neural network, to generate a classification result for a first portion of the audio signal; and
based on determining that the classification result indicates that the first portion of the audio signal corresponds to relevant audio, updating a headset configuration of a headset to enable a second portion of the audio signal to be output by the headset.

22. The method of claim 21, further comprising resetting the headset configuration in response to receiving a user input indicating that the headset configuration is to be reset.

23. The method of claim 22, further comprising updating the audio classifier based on a comparison of a first time of the update to the headset configuration and a second time of receipt of the user input.

24. The method of claim 23, further comprising updating the audio classifier by providing positive feedback associated with the classification result to the audio classifier in response to determining that a difference between the first time and the second time is greater than or equal to a threshold duration.

25. The method of claim 23, further comprising updating the audio classifier by providing negative feedback associated with the classification result to the audio classifier in response to determining that a difference between the first time and the second time is less than a threshold duration.

26. A non-transitory computer-readable storage device storing instructions that, when executed by a processor, cause the processor to:
receive an audio signal corresponding to audio received by one or more microphones;
process the audio signal using an audio classifier, wherein the audio classifier comprises a neural network, to generate a classification result for a first portion of the audio signal; and
based on determining that the classification result indicates that the first portion of the audio signal corresponds to relevant audio, update a headset configuration of a headset to enable a second portion of the audio signal to be output by the headset.

27. The non-transitory computer-readable storage device of claim 26, wherein updating the headset configuration includes reducing an output volume of a second audio signal output by the headset.

28. The non-transitory computer-readable storage device of claim 26, wherein updating the headset configuration includes deactivating a filter setting of the headset.

29. An apparatus for headphone audio management, the apparatus comprising:
means for processing an audio signal corresponding to audio received by one or more microphones using an audio classifier, wherein the audio classifier comprises a neural network, to generate a classification result for a first portion of the audio signal; and
means for updating a headset configuration of a headset to enable a second portion of the audio signal to be output by the headset, the headset configuration updated based on determining that the classification result indicates that the first portion of the audio signal corresponds to relevant audio.

30. The apparatus of claim 29, wherein the means for processing, and the means for updating are integrated into at least one of the headset, a mobile device, a mobile phone, a portable electronic device, a car, a vehicle, a computing device, a communication device, an internet-of-things (IoT) device, a virtual reality (VR) device, or an augmented reality (AR) device.
